(19) United States
(12) Patent Application Publication
(10) Pub. No.: US 2011/0261001 A1
(43) Pub. Date: Oct. 27, 2011

(54) APPARATUS AND METHOD FOR IMPACT RESISTANT TOUCHSCREEN DISPLAY MODULE

(76) Inventor: Jin Liu, Mississauga (CA)

(21) Appl. No.: 12/765,945

(22) Filed: Apr. 23, 2010

(51) Int. Cl. G06F 3/045

(52) U.S. Cl. 345/174

(57) ABSTRACT

A method and apparatus for an impact resistant touchscreen display module, such as for use in ruggedized handheld computing and display devices. The structure provided also allows for severability of the touchscreen and display screen portions, enhancing the practicability of replacing individual components for repair of a damaged touchscreen display module.

### FIELD

The present disclosure relates generally to a method and apparatus for an impact resistant touchscreen display module, for use in computing and display devices, including handheld computing devices.

### BACKGROUND

Given the proliferation of handheld mobile computing devices, ruggedization has become an important factor in enhancing their usefulness. It is expected that handheld or mobile devices will be dropped from time to time during handling in normal usage, for instance. This introduces an additional factor of vulnerability. To the extent that the handheld device may be made more robust and reliable when subjected to inadvertent physical abuse in normal usage, the utility to a user of such devices is enhanced.

Screen display assemblies incorporating a touch-sensitive panel, or touchscreen, overlaying a display screen are known. Touchscreens are especially desirable for use in mobile computing and communication devices, where keyboard and mouse systems do not allow a satisfactory, intuitive, rapid, or accurate interaction by the user with the display's content. The touchscreen enables one to interact directly with the information displayed on the display screen, rather than indirectly in the case of a mouse or touchpad. Secondly, a user may interact in that manner without need for any intermediate device, again, such as a stylus that needs to be held in the hand. Touchscreen panels are commonly overlayed on display screens of mobile computers and cell phones.

The touchscreen panel and display screen included in the display screen module represent typically the most expensive components of a mobile device such as a personal digital assistant (PDA) having touchscreen capability. Furthermore, as these components are conventionally bonded together during assembly of the display screen module, typically using optically clear adhesive, the entire display screen module must be discarded if the relatively brittle display screen shatters due to a physical impact, for instance, and cannot be economically repaired.

Consequently, a solution which enhances the resistance or robustness of the display screen module to physical impact, and even further, allows severability of the touchscreen and display screen during any repair would be advantageous.

### SUMMARY OF THE INVENTION

Provided is a touchscreen display module for use in a graphical user interface of an electronic device comprising a touchscreen panel having a generally planar disposition, the touchscreen panel comprising a touch-sensitive region surrounded by a non-touch sensitive periphery, the touch-sensitive region comprising a substantial portion of the touchscreen panel; a rigid spacer underlaying the non-touch sensitive periphery of the touchscreen panel, the rigid spacer securely disposed in contact with non-touch sensitive periphery of the touchscreen panel by an adhesive layer; a compliant layer underlaying the rigid spacer, the compliant layer disposed in contact with the rigid spacer; a display screen underlaying the compliant layer, the display screen having a generally planar display portion provided to directly underlay the touch-sensitive region of the touchscreen; and a touchscreen housing assembly comprising a base bezel portion and a top bezel portion, the touchscreen housing assembly adapted to securely frame the display screen, the compliant layer, the rigid spacer, and the touchscreen panel.

Also provided is a handheld device comprising a processor; a memory coupled to the processor having instructions stored therein for execution by the processor; a touchscreen display module for displaying graphical images processed by the processor using the instructions stored in the memory, the touchscreen display module comprising: a touchscreen panel having a generally planar disposition, the touchscreen panel comprising a touch-sensitive region surrounded by a non-touch sensitive peripheral region, the touch-sensitive region comprising a substantial portion of the touchscreen panel; a rigid spacer shaped to underlay the non-touch sensitive peripheral region of the touchscreen panel; a compliant layer underlaying the rigid spacer, the compliant layer disposed in contact with the rigid spacer; a display screen underlaying the compliant layer, the display screen having a generally planar display portion provided to directly underlay the touch-sensitive region of the touchscreen; and a touchscreen housing assembly comprising a base bezel portion and a top bezel portion, the touchscreen housing assembly adapted to securely frame the display screen, the compliant layer, the rigid spacer, and the touchscreen panel.

Also provided is a method for assembling a touchscreen display module comprising providing a touchscreen panel having a generally planar disposition, the touchscreen panel comprising a touch-sensitive region surrounded by a non-touch sensitive periphery, the touch-sensitive region comprising a substantial portion of the touchscreen panel; providing a rigid spacer underlaying the non-touch sensitive periphery of the touchscreen panel, the rigid spacer securely disposed in contact with non-touch sensitive periphery of the touchscreen panel by an adhesive layer; providing a compliant layer underlaying the rigid spacer, the compliant layer disposed in contact with the rigid spacer; providing a display screen underlaying the compliant layer, the display screen having a generally planar display portion provided to directly underlay the touch-sensitive region of the touchscreen; and providing a touchscreen housing assembly comprising a base bezel portion and a top bezel portion, the touchscreen housing assembly adapted to securely frame the display screen, the compliant layer, the rigid spacer, and the touchscreen panel.

### BRIEF DESCRIPTION OF THE DRAWINGS

Embodiments will now be described by way of example only, with reference to the following drawings in which:

FIG. 1 illustrates an exemplary handheld device having an impact resistant touchscreen display module;

FIG. 2 is an exemplary conceptual diagram illustrating an embodiment of the electronic components and functional subsystems of the handheld device, including an impact resistant touchscreen display module;

FIG. 3 is an conceptual diagram showing an exemplary structure of sub-assembly components of the impact resistant touchscreen display module which may be incorporated into the handheld device.

### DETAILED DESCRIPTION

It would be advantageous to provide an impact-resistant touchscreen display module, embodied in a structure which does not add physical bulk and complexity, to the handheld devices.

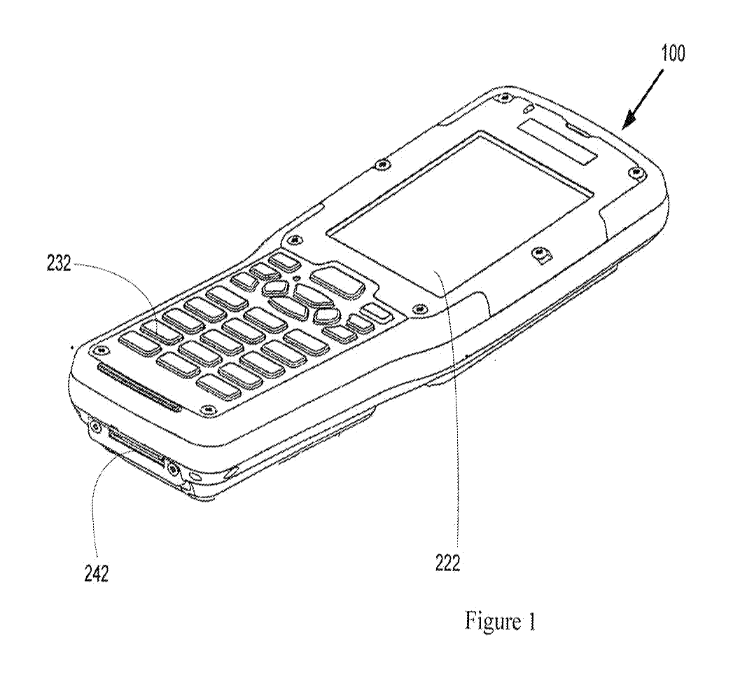

Referring now more particularly to the accompanying figures, FIG. 1 illustrates an exemplary embodiment of a handheld computer 100 (herein referred to variously and interchangeably as a handheld device, a mobile computer, or a mobile device) in accordance with the disclosure herein. The handheld computer may have the capability of communicating at least data, and possibly both data and audio, to and from servers as well as data acquisition sources within a communication network. Impact resistant touchscreen display module 222 may be incorporated into the handheld device 100.

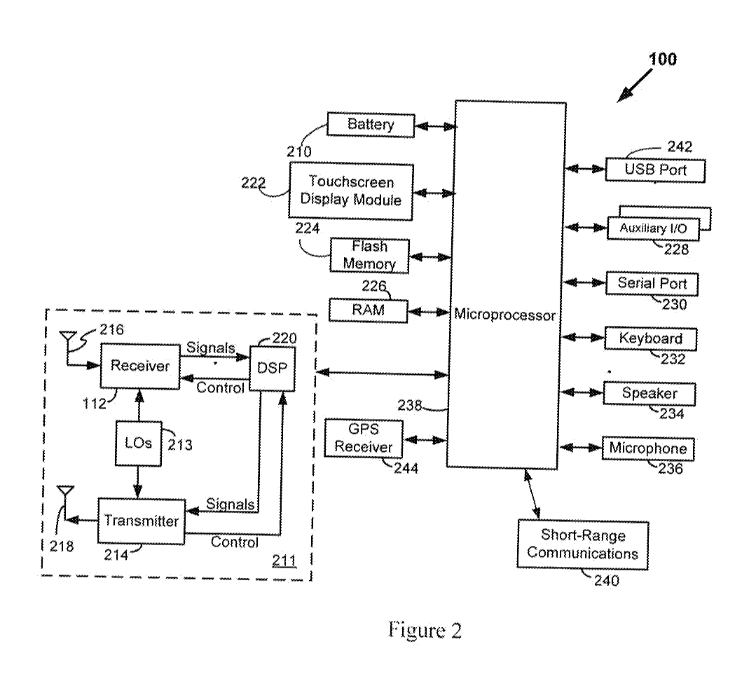

Referring now to FIG. 2, the handheld device 100 may include a radio frequency (RF) communication subsystem 211, which includes a receiver 212, a transmitter 214, and associated components, such as one or more embedded or internal antenna elements 216 and 218, local oscillators (LOs) 213, and a processing module such as a digital signal processor (DSP) 220. As will be apparent to those skilled in field of communications, the particular design of the RF communication subsystem 211 depends on the communication network in which handheld device 100 is intended to operate, but may include communication functionalities such as radio-frequency identification (RFID), Wi-Fi WLAN based on 802.11 standards, and the like.

The handheld device 100 includes a microprocessor 238 which controls general operation of the handheld device 100. The microprocessor 238 also interacts with functional device subsystems such as touchscreen display module 222, a flash memory 224, random access memory (RAM) 226, auxiliary input/output (I/O) subsystems 228, serial port 230, keyboard 232, speaker 234, microphone 236, short-range communications subsystem 240 such as Bluetooth™ for example, and Universal Serial Bus (USB) expansion port 242 for peripheral. The handheld device 100 may include a power source 210, such as a rechargeable battery which may also be removable and replaceable from the handheld device. The handheld device 100 may also include a positioning device 244, such as a GPS receiver for example, for receiving positioning information.

Operating system software used by the microprocessor 238 may be stored in a persistent store such as the flash memory 224, which may alternatively be a read-only memory (ROM) or similar storage element (not shown). Those skilled in the art will appreciate that the operating system, specific device applications, or parts thereof, may be temporarily loaded into a volatile store such as RAM 226.

The microprocessor 238, in addition to its operating system functions, enables execution of software applications on the handheld device 100. A predetermined set of applications, which control basic device operations, may be installed on the handheld device 100 during its manufacture. These basic operations typically include data and voice communication applications, for example. Additionally, applications may also be subsequently loaded onto the handheld device 100 through the communication subsystem 211, an auxiliary I/O subsystem 228, serial port 230, USB port 242, short-range communications subsystem 240, or any other suitable subsystem, and installed by a user in RAM 226, or the persistent store 224, for execution by the microprocessor 238. Such flexibility in application installation increases the functionality of the handheld device 100 and may provide enhanced on-device features, communication-related features, or both.

Touchscreen display module 222 is used to visually present an application's graphical user interface (GUI) to the user. The user can manipulate application data by modifying information on the GUI using direct touches by finger. Depending on the type of handheld device 100, the user may have access to other types of input devices, such as, for example, a scroll wheel, trackball, light pen or touch sensitive screen.

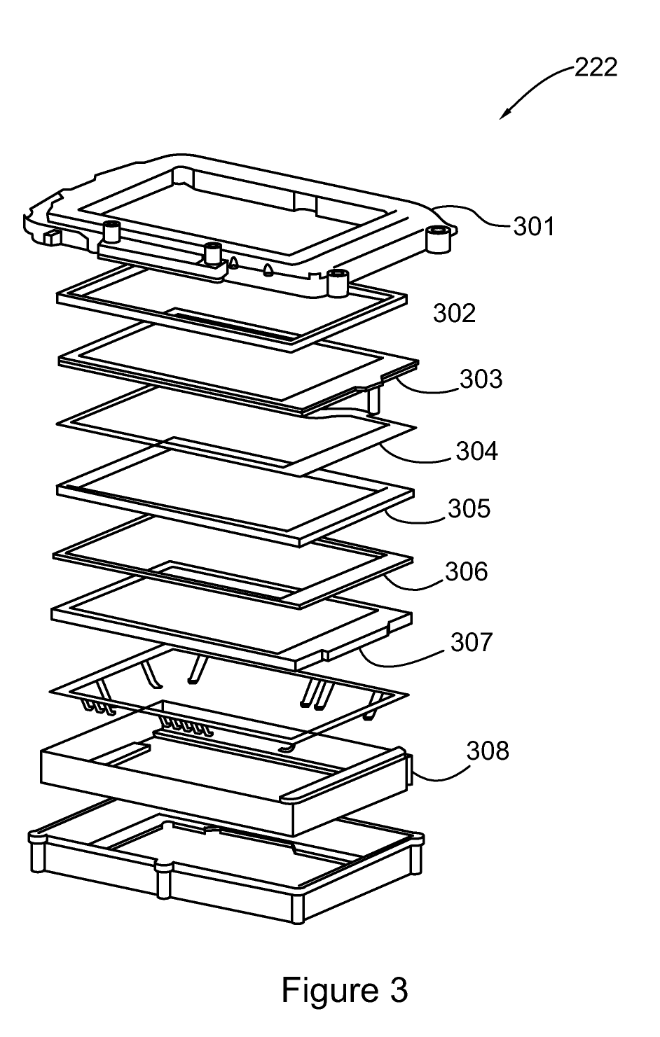

FIG. 3 illustrates an exemplary structuring of sub-assembly components of the impact resistant touchscreen display module which may be incorporated into the handheld device 100.

Touchscreen display module 222 may be structured and assembled as follow. A touchscreen panel 303 of a generally planar disposition comprises a touch-sensitive region surrounded by a non-touch sensitive periphery. Typically, both the touch-sensitive region and its non-touch sensitive periphery are rectangular in shape; however, other shapes and even irregular geometries are contemplated. The touch-sensitive region comprises the majority of the area of the touchscreen panel 303, relative to the non-touch sensitive periphery. The touch-sensitive region of touchscreen panel 303 may be a resistive, an acoustic, a capacitive, an infrared and a force-sensitive touchscreen, or any combination thereof.

A rigid spacer 305 is provided underlaying the non-touch sensitive periphery of the touchscreen panel 303, the rigid spacer 305 securely disposed in contact with non-touch sensitive periphery of the touchscreen panel 303 by application of an adhesive layer 304. The rigid spacer is typically fabricated of rigid or other rigid material such as a rigid plastic material, and functions to more evenly distribute the sealing pressure around the periphery of the touchscreen panel while enhacing the rigidity of the touchscreen panel.

A compliant layer 306 is provided underlaying the rigid spacer, the compliant layer 306 disposed in contact with the rigid spacer. Compliant layer 306 may be selected from the group of compliant materials consisting of a foam, a gel, and a therm-plastic elastomer.

A display screen 307 is provided underlaying the compliant layer, the display screen 307 having a generally planar display portion provided to directly underlay the touch-sensitive region of the touchscreen. Compliant layer 306 in conjunction with rigid spacer 305 described above provide impact-resistance for display screen 307 during any shock or impact to the touchscreen display module 222. Consequently, an optimal thickness of rigid spacer 305 will determine the shock-resistance ability. While a thick rigid spacer 305 results in better shock-resistance capability, too thick results in display distortions when viewing display screen 307. On the other hand, a too thin rigid spacer 305 compromises the shock-resistant properties of the display screen 307. It is contemplated that drop or shock tests in conjunction with viewing of display quality across a selection of thicknesses of rigid spacer 305 may be used to empirically determine the optimal thickness for rigid spacer.

A touchscreen display module housing assembly comprises a base bezel portion 308 and a top bezel portion 301 adapted to securely frame the display screen 307, the compliant layer 306, the rigid spacer 305, and the touchscreen panel 303.

The touchscreen display module 222 may further include a sealing layer 302 interposed between the non-touch sensitive periphery of the touchscreen panel 303 and the top bezel portion 301. The sealing layer 302 is typically composed of a chemical-resistant, dust-resistant and shock-resistant compliant material, such as a rubber- or elastomer-based compound.

Still with regard to FIG. 3, the structure provided also allows for severability of the touchscreen panel 303 and display screen 307 portions during repair of the touchscreen display module 222. This enhances the practicability and economics of replacing individual components during repair of a damaged touchscreen display module 222.

Although a mobile or handheld computer has been used to establish a context for disclosure herein, it is contemplated as having much wider applicability within the field of touchscreen display devices. Furthermore, the disclosure herein has been described with reference to specific exemplary embodiments; however, varying modifications thereof will be apparent to those skilled in the art without departing from the scope of the invention as defined by the appended claims.

What is claimed is:

1. A touchscreen display module for use in a graphical user interface of an electronic device comprising:
a touchscreen panel having a generally planar disposition, the touchscreen panel comprising a touch-sensitive region surrounded by a non-touch sensitive periphery, the touch-sensitive region comprising a substantial portion of the touchscreen panel;
a rigid spacer underlaying the non-touch sensitive periphery of the touchscreen panel, the rigid spacer securely disposed in contact with non-touch sensitive periphery of the touchscreen panel by an adhesive layer;
a compliant layer underlaying the rigid spacer, the compliant layer disposed in contact with the rigid spacer;
a display screen underlaying the compliant layer, the display screen having a generally planar display portion provided to directly underlay the touch-sensitive region of the touchscreen; and
a touchscreen housing assembly comprising a base bezel portion and a top bezel portion, the touchscreen housing assembly adapted to securely frame the display screen, the compliant layer, the rigid spacer, and the touchscreen panel.

2. The touchscreen display module of claim 1 further comprising a sealing layer interposed between the non-touch sensitive periphery of the touchscreen panel and the top bezel portion.

3. The touchscreen display module of claim 3 wherein the sealing layer comprises a chemical-resistant, dust-resistant and shock-resistant compliant material.

4. The touchscreen display module of claim 1 wherein the compliant layer is a selected from the group of compliant materials consisting of a foam, a gel, and a thermo-plastic elastomer.

5. The touchscreen display module of claim 1 wherein at least the touch-sensitive region of the touchscreen panel is selected from the group of touchscreens consisting of a resistive, an acoustic, a capacitive, an infrared and a force-sensitive touchscreen.

6. The touchscreen display module of claim 1 wherein the touch-sensitive region of the touchscreen panel is rectangular in shape.

7. A handheld device comprising:
a processor;
a memory coupled to the processor having instructions stored therein for execution by the processor;
a touchscreen display module for displaying graphical images processed by the processor using the instructions stored in the memory, the touchscreen display module comprising:
a touchscreen panel having a generally planar disposition, the touchscreen panel comprising a touch-sensitive region surrounded by a non-touch sensitive peripheral region, the touch-sensitive region comprising a substantial portion of the touchscreen panel;
a rigid spacer shaped to underlay the non-touch sensitive peripheral region of the touchscreen panel;
a compliant layer underlaying the rigid spacer, the compliant layer disposed in contact with the rigid spacer;
a display screen underlaying the compliant layer, the display screen having a generally planar display portion provided to directly underlay the touch-sensitive region of the touchscreen; and
a touchscreen housing assembly comprising a base bezel portion and a top bezel portion, the touchscreen housing assembly adapted to securely frame the display screen, the compliant layer, the rigid spacer, and the touchscreen panel.

8. The handheld device of claim 7 further comprising a sealing layer interposed between the non-touch sensitive periphery of the touchscreen panel and the top bezel portion.

9. The handheld device of claim 8 wherein the sealing layer comprises a chemical-resistant, dust-resistant and shock-resistant compliant material.

10. The handheld device of claim 7 wherein the compliant layer is a selected from the group of compliant materials consisting of a foam, a gel, and a thermo-plastic elastomer.

11. The handheld device of claim 7 wherein at least the touch-sensitive region of the touchscreen panel is selected from the group of touchscreens consisting of a resistive, an acoustic, a capacitive, an infrared and a force-sensitive touchscreen.

12. A method for assembling a touchscreen display module comprising:
providing a touchscreen panel having a generally planar disposition, the touchscreen panel comprising a touch-sensitive region surrounded by a non-touch sensitive periphery, the touch-sensitive region comprising a substantial portion of the touchscreen panel;
providing a rigid spacer underlaying the non-touch sensitive periphery of the touchscreen panel, the rigid spacer securely disposed in contact with non-touch sensitive periphery of the touchscreen panel by an adhesive layer;
providing a compliant layer underlaying the rigid spacer, the compliant layer disposed in contact with the rigid spacer;
providing a display screen underlaying the compliant layer, the display screen having a generally planar display portion provided to directly underlay the touch-sensitive region of the touchscreen; and
providing a touchscreen housing assembly comprising a base bezel portion and a top bezel portion, the touchscreen housing assembly adapted to securely frame the display screen, the compliant layer, the rigid spacer, and the touchscreen panel.

13. The method of claim 12 further comprising providing a sealing layer interposed between the non-touch sensitive periphery of the touchscreen panel and the top bezel portion.

14. The method of claim 13 wherein the sealing layer comprises a chemical-resistant, dust-resistant and shock-resistant compliant material.

15. The method of claim 12 further comprising providing the compliant layer selected from the group of compliant materials consisting of a foam, a gel, and a thermo-plastic elastomer.

16. The method of claim 12 further comprising providing at least the touch-sensitive region of the touchscreen panel selected from the group of touchscreens consisting of a resistive, an acoustic, a capacitive, an infrared and a force-sensitive touchscreen.
